(19) United States
(12) Patent Application Publication
(10) Pub. No.: US 2022/0229273 A1
(43) Pub. Date: Jul. 21, 2022

(54) Optical Imaging System, Recognition Module and Electronic Device

(71) Applicant: ZHEJIANG SUNNY OPTICS CO.,LTD., Ningbo (CN)

(72) Inventors: Jiachen CUI, Ningbo, Zhejiang (CN); Fujian DAI, Ningbo, Zhejiang (CN); Liefeng ZHAO, Ningbo, Zhejiang (CN)

(21) Appl. No.: 17/553,834

(22) Filed: Dec. 17, 2021

(30) Foreign Application Priority Data
Jan. 21, 2021 (CN) 202110081570.8

(51) Int. Cl. G02B 13/00; G02B 9/12

(52) U.S. Cl. CPC G02B 13/0035; G02B 9/12

(57) ABSTRACT

The disclosure provides an optical imaging system, which sequentially includes from an object side to an image side along an optical axis: a first lens with a negative refractive power, an object-side surface thereof is a concave surface; a second lens with a positive refractive power; and a third lens with a positive refractive power; wherein an effective focal length f of the optical imaging system and, an Entrance Pupil Diameter (EPD) of the optical imaging system satisfy: f/EPD<1.6; an effective focal length f2 of the second lens and an effective focal length f3 of the third lens satisfy a conditional expression: 0.5<f2/f3<1.7; and Semi-FOV is a half of a maximum field of view of the optical imaging system satisfies: Semi-FOV>70°.

### CROSS-REFERENCE TO RELATED PRESENT INVENTION(S)

The disclosure claims priority to and the benefit of Chinese Patent Present invention No. 202110081570.8, filed in the China National Intellectual Property Administration (CNIPA) on 21 Jan. 2021, which is incorporated herein by reference in its entirety.

### TECHNICAL FIELD

The disclosure relates to the technical field of optical imaging, and more particularly relates to an optical imaging system with three lenses, a recognition module and an electronic device.

### BACKGROUND

The mobile phone screens are mainly classified into a liquid crystal display (LCD) screen and an organic light-emitting diode (OLED) screen according to the types of light sources. The OLED screen has desirable light transmittance, so the under-screen fingerprint recognition device can receive the reflected light emitted from the OLED screen and reflected by a finger to detect the fingerprint. The under-screen fingerprint recognition device needs to match a corresponding optical system, but a traditional optical system has a large size, a small field of view, a small aperture, etc., causing the imaging quality not desirable enough and influencing the working effect of the recognition device, so the existing recognition device needs to be optimized, and an optical imaging system with a small size, a large field of view, a large aperture and the desirable imaging quality is needed.

### SUMMARY

The disclosure aims to provide an optical imaging system with three lenses. The optical imaging system has a small size, a large field of view, a large aperture and desirable imaging quality.

An embodiment of the disclosure provides an optical imaging system, which sequentially includes from an object side to an image side along an optical axis: a first lens with a negative refractive power, an object-side surface thereof is a concave surface; a second lens with a positive refractive power; and a third lens with a positive refractive power.

Wherein an effective focal length f of an optical imaging system and, an Entrance Pupil Diameter (EPD) of the optical imaging system satisfy: f/EPD<1.6; and Semi-FOV is a half of a maximum field of view of the optical imaging system, and Semi-FOV satisfies: Semi-FOV>70°.

In an implementation mode, an effective focal length f2 of the second lens, an effective focal length f3 of the third lens and an effective focal length f₁ of the first lens satisfy: 2.0<|(f2+f3)/f1|<2.5.

In an implementation mode, an effective focal length f3 of the third lens, a curvature radius R5 of an object-side surface of the third lens and a curvature radius R6 of an image-side surface of the third lens satisfy: −1.6<f3/R5+f3/R6<−0.9.

In an implementation mode, the effective focal f length of the optical imaging system, Semi-FOV and a curvature radius R3 of an object-side surface of the second lens satisfy: 1.5<f*tan(Semi-FOV)/R3<4.0.

In an implementation mode, a center thickness CT3 of the third lens on the optical axis and an edge thickness ET3 of the third lens satisfy: 1.5<CT3/ET3<2.1.

In an implementation mode, YO is an object height of a maximum imaging height of the optical imaging system, lmgH is a half of a diagonal length of an effective pixel region on an imaging surface, and YO and lmgH satisfy: 4.0<YO/lmgH<5.5.

In an implementation mode, TD is an on-axis distance from the object-side surface of the first lens to an image-side surface of the last lens, TO is a distance from a photographed object to the object-side surface of the first lens on the optical axis, and TD and TO satisfy: 0.5<TD/TO<1.0.

In an implementation mode, an on-axis distance SL from an aperture to the imaging surface satisfies: 1.0 mm<SL<1.5 mm.

In an implementation mode, SAG12 is an on-axis distance from an intersection point of an image-side surface of the first lens and the optical axis to an effective radius vertex of the image-side surface of the first lens, and SAG12 and an air space T12 between the first lens and the second lens on the optical axis satisfy: 1.0<SAG12/T12<1.5.

In an implementation mode, the optical imaging system further includes a glass screen arranged between the object side and the first lens.

Another embodiment of the disclosure provides an optical imaging system, which sequentially includes from an object side to an image side along an optical axis: a first lens with a negative refractive power, an object-side surface thereof is a concave surface; a second lens with a refractive power; and a third lens with a refractive power.

Wherein, each lens is independent of each other, and an air space is formed between each lens on the optical axis; an effective focal length f2 of the second lens and an effective focal length f3 of the third lens satisfy: 0.5<f2/f3<1.7; and Semi-FOV is a half of a maximum field of view of the optical imaging system, and Semi-FOV satisfies: Semi-FOV>70°.

Another embodiment of the disclosure provides a recognition module, which includes the above optical imaging system and an electronic photosensitive element, wherein the electronic photosensitive element is arranged on an imaging surface of the optical imaging system.

Another embodiment of the disclosure provides an electronic device, which includes the above recognition module.

The beneficial effects of the disclosure:

The optical imaging system provided by the disclosure includes multiple lenses, for example, the first lens to the third lens. The optical imaging system in the disclosure has a small size, a large field of view, a large aperture and desirable imaging quality.

### BRIEF DESCRIPTION OF THE DRAWINGS

In order to explain the technical solutions in embodiments of the disclosure more clearly, the accompanying drawings required in the description of the embodiments will be described below briefly. Apparently, the accompanying drawings in the following description show merely some embodiments of the disclosure, and other drawings can be derived from these accompanying drawings by those skilled in the art without creative efforts.

FIG. 1 shows a structural schematic diagram of a lens group of an optical imaging system according to Embodiment 1 of the disclosure;

FIGS. 2a-2c show a longitudinal aberration curve, a distortion curve and a lateral color curve of an optical imaging system according to Embodiment 1 of the disclosure;

FIG. 3 shows a structural schematic diagram of a lens group of an optical imaging system according to Embodiment 2 of the disclosure;

FIGS. 4a-4c shows a longitudinal aberration curve, a distortion curve and a lateral color curve of an optical imaging system according to Embodiment 2 of the disclosure;

FIG. 5 shows a structural schematic diagram of a lens group of an optical imaging system according to Embodiment 3 of the disclosure;

FIGS. 6a-6c shows a longitudinal aberration curve, a distortion curve and a lateral color curve of an optical imaging system according to Embodiment 3 of the disclosure;

FIG. 7 shows a structural schematic diagram of a lens group of an optical imaging system according to Embodiment 4 of the disclosure;

FIGS. 8a-8c shows a longitudinal aberration curve, a distortion curve and a lateral color curve of an optical imaging system according to Embodiment 4 of the disclosure;

FIG. 9 shows a structural schematic diagram of a lens group of an optical imaging system according to Embodiment 5 of the disclosure;

FIGS. 10a-10c shows a longitudinal aberration curve, a distortion curve and a lateral color curve of an optical imaging system according to Embodiment 5 of the disclosure; and

FIG. 11 shows a schematic diagram of YO and TO parameters of an optical imaging system of the disclosure.

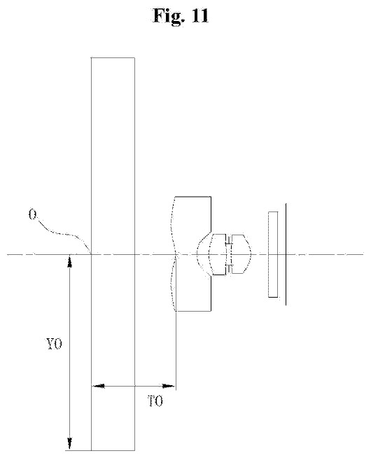

### DETAILED DESCRIPTION OF THE EMBODIMENTS

The technical solutions of embodiments of the disclosure will be described below clearly and comprehensively in conjunction with accompanying drawings of the embodiments of the disclosure. Apparently, the embodiments described are merely some embodiments rather than all embodiments of the disclosure. Basing on the embodiments of the disclosure, all other embodiments acquired by those skilled in the art without making creative efforts fall within the scope of protection of the disclosure.

It should be noted that throughout this specification, the recitations of first, second, third, etc. are used merely to distinguish one feature from another and do not represent any limitation on the feature. Thus, the first lens discussed below may also be referred to as the second lens or the third lens without departing from the teachings of the disclosure.

It should also be understood that the terms “comprises,” “comprising,” “has,” “includes,” and/or “including,” when used in this specification, indicate the presence of stated features, elements, and/or components, but do not preclude the presence or addition of one or more other features, elements, components, and/or combinations thereof. Further, when a statement such as “at least one of . . . ” appears after a list of listed features, the entire listed feature is modified, rather than modifying an individual element in the list. Further, when describing embodiments of the disclosure, the use of “may” means “one or more embodiments of the disclosure”. In addition, the term “exemplary” is intended to refer to an example, or illustration.

In the accompanying drawings, the thickness, size, and shape of the lens have been slightly exaggerated for ease of illustration. Specifically, a spherical or aspheric shape, shown in the accompanying drawings, is illustrated by way of example. That is to say that the spherical or aspheric shape is not limited to the spherical or aspheric shape shown in the accompanying drawings. The drawings are examples only and are not drawn to scale strictly.

A paraxial region refers herein to a region near an optical axis. If a surface of a lens is a convex surface and a position of the convex surface is not defined, the surface of the lens is a convex surface at least in the paraxial region. If the surface of the lens is a concave surface and the position of the concave surface is not defined, the surface of the lens is a concave surface at least in the paraxial region. A surface, closest to a shot object, of each lens is called the object-side surface of the lens, and a surface, closest to an imaging surface, of each lens is called the image-side surface of the lens.

All terms (including technical and scientific terms) used herein have the same meaning as commonly understood by those skilled in the art to which this disclosure belongs unless otherwise defined. It should also be understood that terms (for example, terms defined in commonly used dictionaries) should be interpreted as having a meaning that is consistent with their meaning in the context of the relevant art and will not be interpreted in an idealized or overly formalized sense unless expressly so defined herein.

It should be noted that the embodiments of the disclosure and the features of the embodiments may be combined with each other without conflict. The features, principles, and other aspects of the disclosure are described in detail below with reference to the accompanying diagrams and in conjunction with embodiments.

An optical imaging system according to an exemplary embodiment of the disclosure includes three lenses, and sequentially includes from an object side to an image side along an optical axis: a first lens, a second lens and a third lens, wherein each lens is independent of each other, and an air space is formed between each lens on the optical axis.

In an exemplary embodiment, the first lens has a negative refractive power, and an object-side surface thereof is a concave surface; the second lens may have a positive refractive power or a negative refractive power; and a third lens may have a positive refractive power or a negative refractive power.

In an exemplary embodiment, a total effective focal length f of the optical imaging system and an Entrance Pupil Diameter (EPD) of the optical imaging system satisfy a conditional expression: f/EPD<1.6. By controlling the field of view of the lens and reducing an F-number of the system, the lens may have a larger imaging range. More specifically, f and EPD satisfy: 1<f/EPD<1.55, for example, 1.44≤f/EPD≤1.51.

In an exemplary embodiment, Semi-FOV is a half of a maximum field of view of the optical imaging system, and Semi-FOV satisfies a conditional expression: Semi-FOV>70°. By controlling the field of view of the lens and reducing an F-number of the system, the lens may have a larger imaging range. More specifically, Semi-FOV satisfies: 70.2°<Semi-FOV<81°, for example, 70.31°≤Semi-FOV/80.25°.

In an exemplary embodiment, an effective focal length f2 of the second lens and an effective focal length f3 of the third lens satisfy a conditional expression: 0.5<f2/f3<1.7. A spherical aberration and a coma generated by the second lens and the third lens may be effectively balanced, such that spherical aberration and coma contributions of the balanced second lens and third lens may be in a reasonable range, and then sensitivity of the optical system may be in a reasonable level. By controlling the field of view of the lens, the lens may have a larger imaging range. More specifically, f2 and f3 satisfy: 0.9<f2/f3<1.5, for example, 0.99≤f2/f3≤1.45.

In an exemplary embodiment, the effective focal length f2 of the second lens, the effective focal length f3 of the third lens, and an effective focal length f1 of the first lens satisfy a conditional expression: 2.0<|(f2+f3)/f1|<2.5. By restraining a ratio of the effective focal length of the first lens to a sum of the effective focal lengths of the first lens and the third lens within a certain range, it may be guaranteed that the optical lens has a desirable machinability. More specifically, f2, f3 and f1 satisfy: 2.1<|(f2+f3)/f1|<2.4, for example, 2.11≤|(f2+f3)/f1|≤2.36.

In an exemplary embodiment, the effective focal length f3 of the third lens, a curvature radius R5 of an object-side surface of the third lens, and a curvature radius R6 of an image-side surface of the third lens satisfy a conditional expression: −1.6<f3/R5+f3/R6<−0.9. By restraining the effective focal length of the third lens and the curvature radius of the object-side surface of the third lens within a certain range, a refractive power of the system may be reasonably distributed, third-order astigmatism may be controlled within a certain range, and astigmatism generated by front-end optics and rear-end optics of the system is balanced, such that the system has high imaging quality. More specifically, f3, R5 and R6 satisfy: −1.55<f3/R5+f3/R6<−1, for example, −1.52≤f3/R5+f3/R6≤−1.17.

In an exemplary embodiment, Semi-FOV is a half of the maximum field of view of the optical imaging system, an effective focal length f of the optical imaging system, Semi-FOV and a curvature radius R3 of an object-side surface of the second lens satisfy a conditional expression: 1.5<f*tan(Semi-FOV)/R3<4.0. By restraining the half of the maximum field of view of the imaging system, the effective focal length of the imaging system and a ratio of the two to the curvature radius of the object-side surface of the second lens, the system has a large-image-surface imaging effect, and further has high optical performance and a better machining process. More specifically, f, Semi-FOV and R3 satisfy: 1.5<f*tan(Semi-FOV)/R3<3.9, for example, 1.50≤f*tan(Semi-FOV)/R3≤3.84.

In an exemplary embodiment, a center thickness CT3 of the third lens on the optical axis and an edge thickness ET3 of the third lens satisfy a conditional expression: 1.5<CT3/ET3<2.1. By restraining a ratio of the center thickness to the edge thickness of the third lens within a certain range, thickness sensitivity of the lens may be reduced, and a field curvature may be corrected. More specifically, CT3 and ET3 satisfy: 1.6<CT3/ET3<2, for example, 1.67≤CT3/ET3≤1.89.

In an exemplary embodiment, YO is an object height of a maximum imaging height of the optical imaging system and lmgH is a half of a diagonal length of an effective pixel region on an imaging surface, and YO and lmgH satisfy a conditional expression: 4.0<YO/lmgH<5.5. By restraining a ratio of the object height of the maximum imaging height of an optical photographing lens group to the half of the diagonal length of the effective pixel region on the imaging surface, the optical imaging system may obtain a larger field of view. More specifically, YO and lmgH satisfy: 4.3<YO/lmgH<5.4, for example, 4.41≤YO/lmgH≤5.38.

In an exemplary embodiment, TD is an on-axis distance from the object-side surface of the first lens to an image-side surface of the last lens and TO is a distance from a photographed object to the object-side surface of the first lens on the optical axis, and TD and TO satisfy a conditional expression: 0.5<TD/TO<1.0. An on-axis spacing distance from the image-side surface to the object-side surface of the first lens is reasonably configured, such that the thickness sensitivity of the lens may be effectively reduced, and the field curvature may be corrected. More specifically, TD and TO satisfy: 0.6<TD/TO<0.95, for example, 0.77≤TD/TO≤0.94.

In an exemplary embodiment, an on-axis distance SL from an aperture to the imaging surface satisfies a conditional expression: 1.0 mm<SL<1.5 mm. The on-axis distance from the aperture to the imaging surface is reasonably controlled within a certain range, such that a main light angle of the optical imaging system is adjusted, so as to effectively improve relative brightness of the optical imaging system, and improve definition of the image surface. More specifically, SL satisfies: 1.2 mm<SL<1.4 mm, for example, 1.27 mm≤SL≤1.34 mm.

In an exemplary embodiment, SAG12 is an on-axis distance from an intersection point of an image-side surface of the first lens and the optical axis to an effective radius vertex of the image-side surface of the first lens, and T12 is an air space between the first lens and the second lens on the optical axis satisfy a conditional expression: 1.0<SAG12/T12<1.5. The on-axis distance from the intersection point of the image-side surface of the second lens and the optical axis to the effective radius vertex of the image-side surface of the second lens and the air space between the first lens and the second lens on the optical axis are reasonably controlled within a certain range, such that the main light angle of the optical imaging system is adjusted, so as to effectively improve the relative brightness of the optical imaging system, and improve the definition of the image surface. More specifically, SAG12 and T12 satisfy: 1.1<SAG12/T12<1.3, for example, 1.16≤SAG12/T12≤1.22.

In an exemplary embodiment, the above optical imaging system may further include a glass screen arranged between the object side and the first lens. The above optical imaging system may further include a diaphragm, the diaphragm may be arranged at an appropriate position as desired, for example, the diaphragm may be arranged between the object side and the first lens. In an embodiment, the optical imaging system may further include an optical filter used for correcting color deviation and/or a protective glass used for protecting a photosensitive element located on the imaging surface.

The optical imaging system according to the above embodiment of the disclosure may adopt multiple lenses, for example, the three lenses above. By reasonably distributing a refractive power and a surface type of each lens, a center thickness of each lens, an on-axis spacing distance between the lenses, etc., the optical imaging system has a larger imaging image surface, and has features of wide imaging range and high imaging quality, and guarantees ultrathin property of a mobile phone.

In an exemplary embodiment, at least one of the mirror surfaces of each lens is an aspheric mirror surface, that is, at least one mirror surface from an object-side surface of the first lens to an image-side surface of the third lens is an aspheric mirror surface. The aspheric lens is characterized in that the curvature is continuously changed from a center of the lens to a periphery of the lens. Different from a spherical lens with a constant curvature from the center of the lens to the periphery of the lens, the aspheric lens has a better curvature radius feature and has the advantages of improving distortion aberration and astigmatism aberration. After the aspheric lens is used, aberration occurring during imaging may be eliminated as much as possible, thereby improving the imaging quality. In an embodiment, at least one of the object-side surface and the image-side surface of each of the first lens, the second lens and the third lens is an aspheric mirror surface. In another embodiment, the object-side surface and the image-side surface of each of the first lens, the second lens and the third lens are aspheric mirror surfaces.

However, it should be understood by those skilled in the art that the number of lenses constituting the optical imaging system may be varied to obtain various results and advantages described in this specification without departing from the claimed technical solution of the disclosure. For example, although described with three lenses as an example in the embodiment, the optical imaging system is not limited to including three lenses, and the optical imaging system may include other numbers of lenses if desired.

Specific embodiments of the optical imaging system that may be suitable for use in the above embodiments are described further below with reference to the accompanying drawings.

### Embodiment 1

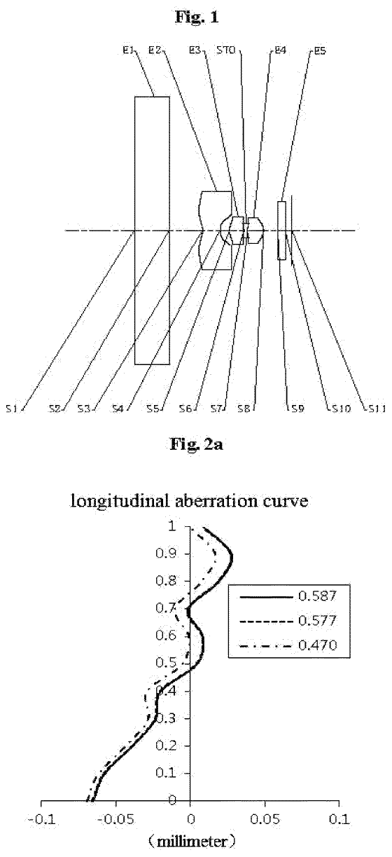

FIG. 1 shows a structural schematic diagram of a lens group of an optical imaging system according to Embodiment 1 of the disclosure. The optical imaging system sequentially includes from an object side to an image side along an optical axis: a glass screen E1, a first lens E2, a second lens E3, a diaphragm STO, a third lens E4, an optical filter E5 and an imaging surface S11.

The glass screen E1 has an object-side surface S1 and an image-side surface S2. The first lens E2 has a negative refractive power, an object-side surface S3 thereof is a concave surface, and an image-side surface S4 thereof is a concave surface. The second lens E3 has a positive refractive power, an object-side surface S5 thereof is a convex surface, and an image-side surface S6 thereof is a convex surface. The third lens E4 has a positive refractive power, an object-side surface S7 thereof is a convex surface, and an image-side surface S8 thereof is a convex surface. The optical filter E5 has an object-side surface S9 and an image-side surface S10. Light from an object sequentially passes through each of the surfaces from S1 to S10 and is finally imaged on the imaging surface S11.

Table 1 shows a table of basic parameters for the optical imaging system of Embodiment 1, wherein the units of the curvature radius, thickness and focal length are all millimeters (mm).

TABLE 1

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinity | 0.0000 | | | | |
| S1 | Spherical | Infinity | 1.0000 | | 1.52 | 64.2 | 0.0000 |
| S2 | Spherical | Infinity | 0.9503 | | | | 0.0000 |
| S3 | Aspheric | −0.5038 | 0.5000 | −0.66 | 1.54 | 56.1 | −1.0000 |
| S4 | Aspheric | 1.6956 | 0.2687 | | | | 0.0000 |
| S5 | Aspheric | 0.6154 | 0.4059 | 0.69 | 1.62 | 25.9 | 0.0000 |
| S6 | Aspheric | −1.0249 | 0.0600 | | | | 0.0000 |
| STO | Spherical | Infinity | 0.0517 | | | | 0.0000 |
| S7 | Aspheric | 2.3804 | 0.4520 | 0.70 | 1.54 | 56.1 | 0.0000 |
| S8 | Aspheric | −0.4213 | 0.4104 | | | | −1.0000 |
| S9 | Spherical | Infinity | 0.2100 | | 1.52 | 64.2 | 0.0000 |
| S10 | Spherical | Infinity | 0.1962 | | | | 0.0000 |
| S11 | Spherical | Infinity | | | | | |

As shown in Table 2, in Embodiment 1, f is a total effective focal length of the optical imaging system, and f=0.33mm, TTL is a distance from the object-side surface S3 of the first lens E2 to the imaging surface S11 on the optical axis, and TTL=2.55 mm, lmgH is a half of a diagonal length of an effective pixel region on the imaging surface S11, and lmgH=1.03 mm, and Semi-FOV is a half of a maximum field of view of the optical imaging system, and Semi-FOV=70.31°.

TABLE 2
Embodiment 1

| | | | |
|---|---|---|---|
| f(mm) | 0.33 | f1(mm) | −0.66 |
| TTL(mm) | 2.55 | ImgH(rnm) | 1.03 |
| Semi-FOV(°) | 70.31 | Fno | 1.44 |
| f/EPD | 1.44 | f2/f3 | 0.99 |
| \|(f2 + f3)/f1\| | 2.11 | f3/R5 + f3/R6 | −1.37 |
| f * tan(Semi-FOV)/R3 | 1.50 | CT3/ET3 | 1.67 |
| YO/ImgH | 4.41 | TD/TO | 0.89 |
| SL (mm) | 1.32 | SAG12/T12 | 1.18 |

The optical imaging system in Embodiment 1 satisfies:

f/EPD=1.44, wherein f is the effective focal length of the optical imaging system , and EPD is a entrance pupil diameter of the optical imaging system;

Semi-FOV=70.31°, wherein Semi-FOV is the half of the maximum field of view of the optical imaging system;

f2/f3=0.99, wherein f2 is an effective focal length of the second lens, and f3 is an effective focal length of the third lens;

|(f2+f3)/f1|=2.11, wherein f2 is the effective focal length of the second lens , f3 is the effective focal length of the third lens, and f1 is an effective focal length of the first lens;

f3/R5+f3/R6=−1.37, wherein f3 is the effective focal length of the third lens, R5 is a curvature radius of the object-side surface of the third lens , and R6 is a curvature radius of the image-side surface of the third lens;

f*tan(Semi-FOV)/R3=1.50, wherein f is the effective focal length of the optical imaging system, Semi-FOV is the half of the maximum field of view of the optical imaging system, and R3 is a curvature radius of the object-side surface of the second lens;

CT3/ET3=1.67, wherein CT3 is a center thickness of the third lens on the optical axis, and ET3 is an edge thickness of the third lens;

YO/lmgH=4.41, wherein YO is an object height of a maximum imaging height of the optical imaging system, and lmgH is the half of the diagonal length of an effective pixel region on an imaging surface;

TD/TO=0.89, wherein TD is an on-axis distance from the object-side surface of the first lens to an image-side surface of the last lens, and TO is a distance from a photographed object to the object-side surface of the first lens on the optical axis;

SL=1.32 mm, wherein SL is an on-axis distance from the aperture to the imaging surface; and

SAG12/T12=1.18, wherein SAG12 is an on-axis distance from an intersection point of the image-side surface of the first lens and the optical axis to an effective radius vertex of the image-side surface of the first lens, and T12 is an air space between the first lens and the second lens on the optical axis.

In Embodiment 1, both of the object-side surface and the image-side surface of any one of the first lens E2 to the third lens E4 are aspheric surfaces, and the surface type x of each aspheric lens may be defined by, but is not limited to, the following aspheric, formula:

$$x = \frac{{ch}^{2}}{1 + \sqrt{1 - ( k + 1 ) {c}^{2} {h}^{2}}} + \sum {Aih}^{i} \qquad ( 1 )$$

wherein x is a vector height of a distance between the aspheric surface and a vertex of the aspheric surface when the aspheric surface is located at a position with the height h in the optical axis direction; c is a paraxial curvature of the aspheric surface, c=1/R (that is, the paraxial curvature c is an inverse of radius of curvature R in Table 1 above); k is a conic coefficient; and Ai is a correction coefficient of the i-th order of the aspheric surface.

In Embodiment 1, both of the object-side surface and the image-side surface of any one of the first lens E2 to the third lens E4 are aspheric surfaces, and Table 3 shows high order terra coefficients A4, A6, A8, A10, A12, A14, A16, A18, A20, A22, A24, A26, A28, and A30 that may be used for each of the aspheric mirror surfaces S3-S8 in Embodiment 1.

TABLE 3

| Surface number | A4 | A6 | A8 | A10 | A12 | A14 | A16 |
|---|---|---|---|---|---|---|---|
| S3 | 1.8933E+00 | −4.2969E−01 | 1.4225E−01 | −5.6213E−02 | 2.5341E−02 | −1.2317E−02 | 6.2690E−03 |
| S4 | 3.9451E−01 | −1.1797E−01 | 2.8260E−02 | 2.7453E−03 | 1.3978E−03 | −2.7813E−03 | 6.3047E−04 |
| S5 | −1.2615E−01 | 5.6973E−03 | −4.1004E−03 | 4.6840E−03 | −1.1101E−03 | 1.6701E−03 | −8.6935E−04 |
| S6 | 5.1861E−02 | −1.4798E−02 | 7.5903E−04 | −1.6728E−03 | −2.0316E−05 | −6.0562E−04 | −2.2130E−04 |
| S7 | −1.0817E−02 | 3.9267E−03 | −1.2750E−03 | 7.1761E−04 | −4.2780E−04 | 5.8909E−04 | −1.8233E−04 |
| S8 | 1.8562E−01 | 2.8519E−02 | 1.0567E−02 | −8.7479E−03 | 1.1402E−03 | 3.5272E−04 | 1.6035E−03 |
| Surface number | A18 | A20 | A22 | A24 | A25 | A28 | A30 |
| S3 | −3.2871E−03 | 1.7625E−03 | −9.5577E−04 | 5.4204E−04 | −2.8704E−04 | 1.0210E−04 | −1.6273E−05 |
| S4 | 3.7490E−04 | 1.2168E−03 | −1.1731E−04 | −8.8593E−04 | −1.9689E−03 | −1.3117E−03 | −8.2552E−04 |
| S5 | 3.6613E−04 | −3.6140E−04 | 5.4467E−04 | 2.3982E−04 | 5.3290E−04 | 1.4251E−04 | 2.1336E−04 |
| S6 | 6.8574E−07 | 1.5446E−04 | −1.4298E−04 | −4.6340E−06 | 1.2709E−05 | 9.4208E−05 | −4.8473E−05 |
| S7 | 7.4251E−05 | −9.8747E−05 | −2.2698E−04 | −8.5808E−06 | 2.0076E−05 | −1.1598E−04 | 1.6957E−04 |
| S8 | −1.1288E−03 | −9.4516E−04 | −2.5090E−04 | 2.6292E−04 | −9.0256E−04 | −1.0046E−04 | 2.4686E−04 |

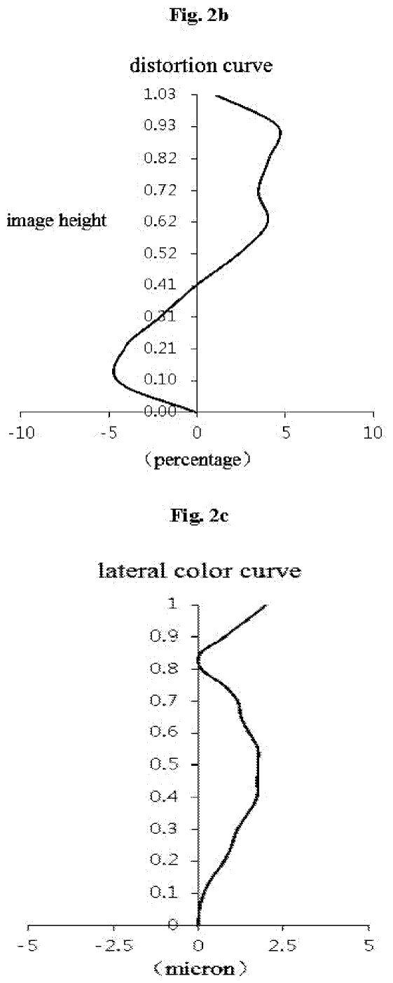

FIG. 2a shows a longitudinal aberration curve of the optical imaging system according to Embodiment 1 to represent deviations of a convergence focal point after light with different wavelengths passes through the lens. FIG. 2b shows a distortion curve of the optical imaging system according to Embodiment 1 to represent distortion values corresponding to different image heights. FIG. 2c shows a lateral color curve of the optical imaging system according to Embodiment 1 to represent deviations of different image heights on the imaging surface after the light passes through the lens. According to FIGS. 2a-2c, it may be seen that the optical imaging system provided in Embodiment 1 is capable of achieving good imaging quality.

### Embodiment 2

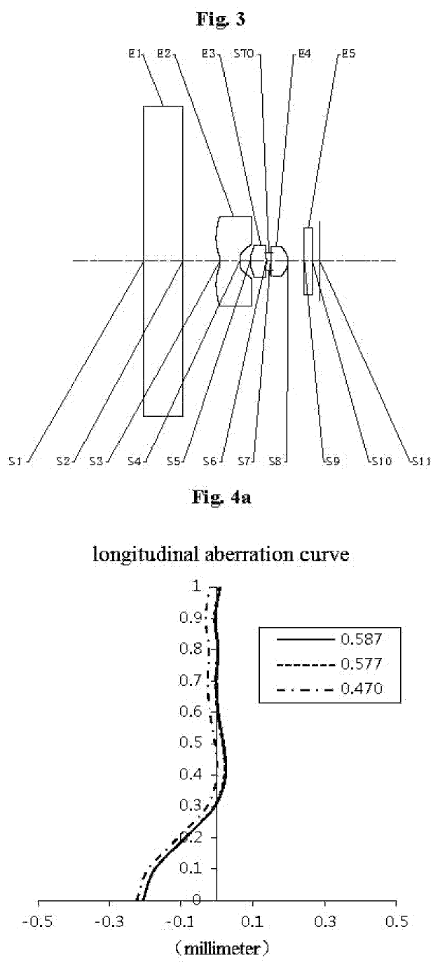

FIG. 3 shows a structural schematic diagram of a lens group of an optical imaging system according to Embodiment 2 of the disclosure. The optical imaging system sequentially includes from an object side to an image side along an optical axis: a glass screen E1, a first lens E2, a second lens E3, a diaphragm STO, a third lens E4, an optical filter E5 and an imaging surface S11.

The glass screen E1 has an object-side surface S1 and an image-side surface S2. The first lens E2 has a negative refractive power, an object-side surface S3 thereof is a concave surface, and an image-side surface S4 thereof is a concave surface. The second lens E3 has a positive refractive power, an object-side surface S5 thereof is a convex surface, and an image-side surface S6 thereof is a convex surface. The third lens E4 has a positive refractive power, an object-side surface S7 thereof is a convex surface, and an image-side surface S8 thereof is a convex surface. The optical filter E5 has an object-side surface S9 and an image-side surface S10. Light from an object sequentially passes through each of the surfaces from S1 to S10 and is finally imaged on the imaging surface S11.

Table 4 shows a table of basic parameters for the optical imaging system of Embodiment 2, wherein the units of the curvature radius, thickness and focal length are all millimeters (mm).

TABLE 4

| Surface | Surface | Curvature | Thickness/ | Focal | Refractive | Abbe | Conic |
|---|---|---|---|---|---|---|---|
| number | type | radius | distance | length | index | number | coefficient |
| OBJ | Spherical | Infinity | 0.0000 | | | | |
| S1 | Spherical | Infinity | 1.0000 | | 1.52 | 64.2 | 0.0000 |
| S2 | Spherical | Infinity | 1.0818 | | | | 0.0000 |
| S3 | Aspheric | −0.4990 | 0.5184 | −0.64 | 1.54 | 56.1 | −1.0000 |
| S4 | Aspheric | 1.5711 | 0.2795 | | | | 0.0000 |
| S5 | Aspheric | 0.5869 | 0.4244 | 0.87 | 1.62 | 25.9 | 0.0000 |
| S6 | Aspheric | −2.0000 | 0.0500 | | | | 0.0000 |
| STO | Spherical | Infinity | 0.0442 | | | | 0.0000 |
| S7 | Aspheric | 1.9166 | 0.4231 | 0.64 | 1.54 | 56.1 | 0.0000 |
| S8 | Aspheric | −0.3907 | 0.3915 | | | | −1.0000 |
| S9 | Spherical | Infinity | 0.2100 | | 1.52 | 64.2 | 0.0000 |
| S10 | Spherical | Infinity | 0.1962 | | | | 0.0000 |
| S11 | Spherical | Infinity | | | | | |

As shown in Table 5, in Embodiment 2, f is a total effective focal length of the optical imaging system, and f=0.34 mm, TTL is a distance from the object-side surface S3 of the first lens E2 to the imaging surface S11 on the optical axis, and TTL=2.54 mm, lmgH is a half of a diagonal length of an effective pixel region on the imaging surface S11, and lmgH=1.02 mm, and Semi-FOV is a half of a maximum field of view of the optical imaging system, and Semi-FOV=79.34°. The parameters of the relational expressions are as explained in Embodiment 1, and numerical values of the relational expressions are listed in the following table.

TABLE 5
Embodiment 2

| | | | |
|---|---|---|---|
| f(mm) | 0.34 | f1(mm) | −0.64 |
| TTL(mm) | 2.54 | ImgH(rnm) | 1.02 |
| Semi-FOV(°) | 79.34 | Fno | 1.51 |
| f/EPD | 1.51 | f2/f3 | 1.36 |
| \|(f2 + f3)/f1\| | 2.36 | f3/R5 + f3/R6 | −1.30 |
| f * tan(Semi-FOV)/R3 | 3.08 | CT3/ET3 | 1.77 |
| YO/ImgH | 4.90 | TD/TO | 0.84 |
| SL(mm) | 1.27 | SAG12/T12 | 1.17 |

In Embodiment 2, both of the object-side surface and the image-side surface of any one of the first lens E2 to the third lens E4 are aspheric surfaces, and Table 6 shows high order term coefficients A4, A6, A8, A10, A12, A14, A16, A18, A20, A22, A24, A26, A28 and A30 that may be used for each of the aspheric mirror surfaces S3-S8 in Embodiment 2.

TABLE 6

| Surface number | A4 | A6 | A8 | A10 | A12 | A14 | A16 |
|---|---|---|---|---|---|---|---|
| S3 | 2.0325E+00 | −4.6218E−01 | 1.5387E−01 | −6.1758E−02 | 2.8187E−02 | −1.3913E−02 | 7.1869E−03 |
| S4 | 3.8935E−01 | −1.1235E−01 | 3.4057E−02 | 4.6142E−03 | 3.9659E−05 | −3.5964E−03 | 1.4148E−03 |
| S5 | −1.3032E−01 | 5.0675E−03 | −2.2258E−03 | 4.7667E−03 | −1.1765E−03 | 1.3486E−03 | −8.0274E−04 |
| S6 | 1.0766E−01 | −4.1994E−02 | 1.4908E−02 | −1.0186E−02 | 1.0800E−02 | −4.5736E−03 | −1.7840E−03 |
| S7 | −8.6108E−03 | 5.4545E−03 | −2.5775E−03 | 4.4477E−04 | −1.8725E−05 | 7.3179E−04 | −4.8526E−05 |
| S8 | 2.2112E−01 | 1.9428E−02 | 7.2245E−04 | −5.3791E−03 | 3.1213E−03 | 6.5449E−04 | −1.0476E−04 |
| Surface number | A18 | A20 | A22 | A24 | A26 | A28 | A30 |
| S3 | −3.8552E−03 | 2.1409E−03 | −1.1967E−03 | 6.9064E−04 | −3.8557E−04 | 1.5104E−04 | −2.6581E−05 |
| S4 | 1.2439E−03 | 1.4016E−03 | −6.4554E−04 | −1.3523E−03 | −1.8045E−03 | −9.6054E−04 | −5.1698E−04 |
| S5 | 4.4186E−04 | −2.5803E−04 | 5.1722E−04 | 1.9494E−04 | 5.1867E−04 | 1.9290E−04 | 2.2139E−04 |
| S6 | 1.5395E−03 | 1.1077E−03 | −8.9611E−04 | −9.4650E−04 | 1.0541E−03 | −6.8668E−05 | −3.3866E−04 |
| S7 | −1.1001E−04 | −4.0873E−04 | −1.3198E−04 | −1.8962E−05 | 1.5745E−04 | 1.2102E−04 | 9.2800E−05 |
| S8 | −1.6151E−03 | 1.7121E−04 | 1.9986E−04 | −1.0079E−04 | −1.0028E−03 | −7.0628E−04 | −3.9907E−04 |

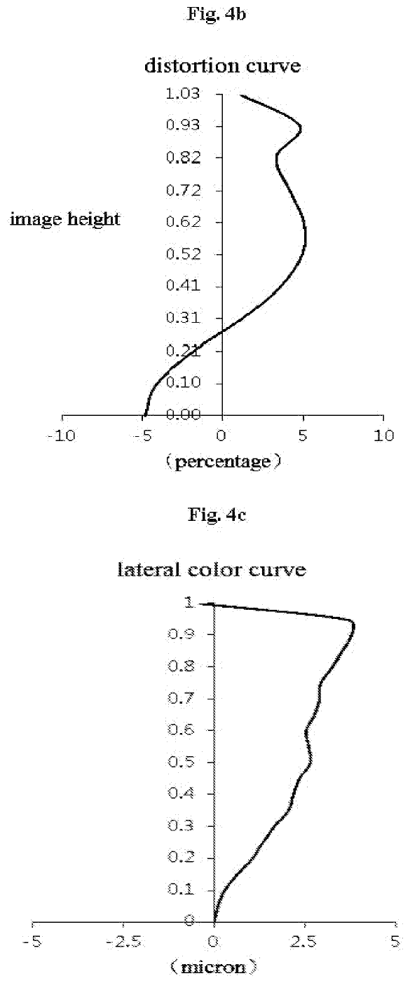

FIG. 4a shows a longitudinal aberration curve of the optical imaging system according to Embodiment 2 to represent deviations of a convergence focal point after light with different wavelengths passes through the lens. FIG. 4b shows a distortion curve of the optical imaging system according to Embodiment 2 to represent distortion values corresponding to different image heights. FIG. 4c shows a lateral color curve of the optical imaging system according to Embodiment 2 to represent deviations of different image heights on the imaging surface after the light passes through the lens. According to FIGS. 4a-4c, it may be seen that the optical imaging system provided in Embodiment 2 is capable of achieving good imaging quality.

### Embodiment 3

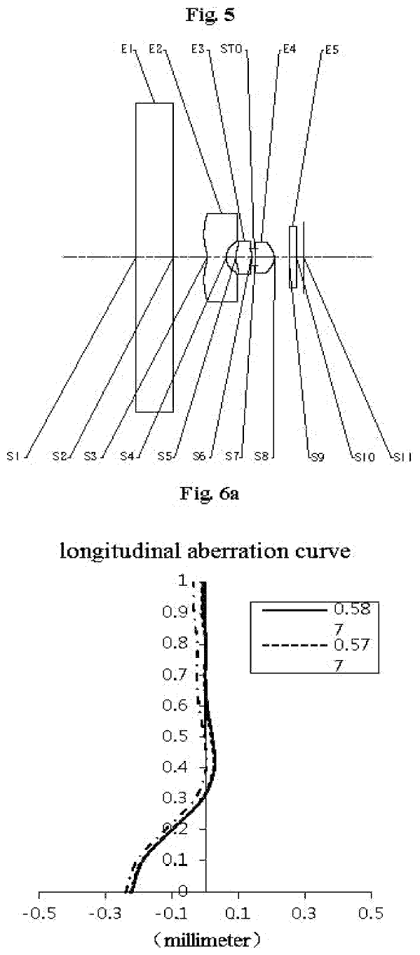

FIG. 5 shows a structural schematic diagram of a lens group of an optical imaging system according to Embodiment 3 of the disclosure. The optical imaging system sequentially includes from an object side to an image side along an optical axis: a glass screen E1, a first lens E2, a second lens E3, a diaphragm STO, a third lens E4, an optical filter E5 and an imaging surface S11.

The glass screen E1 has an object-side surface S1 and an image-side surface S2. The first lens E2 has a negative refractive power, an object-side surface S3 thereof is a concave surface, and an image-side surface S4 thereof is a concave surface. The second lens E3 has a positive refractive power, an object-side surface SS thereof is a convex surface, and an image-side surface S6 thereof is a convex surface. The third lens E4 has a positive refractive power, an object-side surface S7 thereof is a convex surface, and an image-side surface S8 thereof is a convex surface. The optical filter E5 has an object-side surface S9 and an image-side surface SIO. Light from an object sequentially passes through each of the surfaces from S1 to S10 and is finally imaged on the imaging surface S11.

Table 7 shows a table of basic parameters for the optical imaging system of Embodiment 3, wherein the units of the curvature radius, thickness and focal length are all millimeters (mm).

TABLE 7

| Surface | Surface | Curvature | Thickness/ | Focal | Refractive | Abbe | Cone |
|---|---|---|---|---|---|---|---|
| number | type | radius | distance | length | index | number | coefficient |
| OBJ | Spherical | Infinity | 0.0000 | | | | |
| S1 | Spherical | Infinity | 1.0000 | | 1.52 | 64.2 | 0.0000 |
| S2 | Spherical | Infinity | 0.9057 | | | | 0.0000 |
| S3 | Aspheric | −0.4962 | 0.5101 | −0.63 | 1.54 | 56.1 | −1.0000 |
| S4 | Aspheric | 1.4953 | 0.2545 | | | | 0.0000 |
| S5 | Aspheric | 0.6907 | 0.4145 | 0.74 | 1.62 | 25.9 | 0.0000 |
| S6 | Aspheric | −1.0381 | 0.0596 | | | | 0.0000 |
| STO | Spherical | Infinity | 0.0478 | | | | 0.0000 |
| S7 | Aspheric | 3.1327 | 0.5000 | 0.64 | 1.54 | 56.1 | 0.0000 |
| S8 | Aspheric | −0.3701 | 0.3880 | | | | −1.0000 |
| S9 | Spherical | Infinity | 0.2100 | | 1.52 | 64.2 | 0.0000 |
| S10 | Spherical | Infinity | 0.1962 | | | | 0.0000 |
| S11 | Spherical | Infinity | | | | | |

As shown in Table 8, in Embodiment 3, f is a total effective focal length of the optical imaging system, and f=0.32 mm, TTL is a distance from the object-side surface S3 of the first lens E2 to the imaging surface S11 on the optical axis, and TTL=2.58 mm, lmgH is a half of a diagonal length of an effective pixel region on the imaging surface S11, and lmgH=1.02 mm, and Semi-FOV is a half of a maximum field of view of the optical imaging system, and Semi-FOV=78.34°. The parameters of the relational expressions are as explained in Embodiment 1, and numerical values of the relational expressions are listed in the following table.

TABLE 8
Embodiment 3

| | | | |
|---|---|---|---|
| f(mm) | 0.32 | f1(mm) | −0.63 |
| TTL(mm) | 2.58 | ImgH(rnm) | 1.02 |
| Semi-FOV(°) | 78.34 | Fno | 1.46 |
| f/EPD | 1.46 | f2/f3 | 1.16 |
| \|(f2 + f3)/f1\| | 2.19 | f3/R5 + f3/R6 | −1.52 |
| f * tan(Semi-FOV)/R3 | 2.24 | CT3/ET3 | 1.72 |
| YO/ImgH | 4.41 | TD/TO | 0.94 |
| SL(mm) | 1.34 | SAG12/T12 | 1.16 |

In Embodiment 3, both of the object-side surface and the image-side surface of any one of the first lens E2 to the third lens E4 are aspheric surfaces, and Table 9 shows high order term coefficients A4, A6, A8, A10, A12, A14, A16, A18, A20, A22, A24, A26, A28 and A30 that may be used for each of the aspheric mirror surfaces S3-S8 in Embodiment 3.

TABLE 9

| Surface number | A4 | A6 | A8 | A10 | A12 | A14 | A16 |
|---|---|---|---|---|---|---|---|
| S3 | 2.0514E+00 | −4.7430E−01 | 1.6149E−01 | −6.7549E−02 | 3.1440E−02 | −1.5785E−02 | 8.5793E−03 |
| S4 | 3.4924E−01 | −1.3719E−01 | 4.6159E−02 | 6.8398E−03 | −1.2219E−03 | −7.2902E−03 | 2.8636E−03 |
| S5 | −1.2448E−01 | 7.8332E−03 | −3.0208E−03 | 4.5964E−03 | −1.6252E−03 | 1.2783E−03 | −1.0782E−03 |
| S6 | 3.2738E−02 | −1.8552E−02 | −3.0764E−04 | −3.0288E−04 | −1.2292E−05 | −1.6225E−03 | 3.4912E−04 |
| S7 | −1.4375E−02 | 5.5838E−03 | −3.4664E−04 | −2.2668E−04 | 4.6358E−04 | 5.2197E−05 | −1.5453E−04 |
| S8 | 1.8159E−01 | 3.3779E−02 | 1.0975E−02 | −5.8749E−03 | 3.0064E−04 | −3.6106E−04 | 1.5681E−03 |
| Surface number | A18 | A20 | A22 | A24 | A26 | A28 | A30 |
| S3 | −4.8945E−03 | 2.7776E−03 | −1.6753E−03 | 1.0439E−03 | −5.9066E−04 | 3.6985E−04 | −1.3840E−04 |
| S4 | 2.2883E−03 | 1.2061E−03 | −1.6471E−03 | −1.3722E−03 | −1.5049E−03 | −4.6629E−04 | −4.5075E−04 |
| S5 | 4.2047E−04 | −3.5517E−04 | 5.8733E−04 | 1.8138E−04 | 5.0011E−04 | 1.7609E−04 | 3.1664E−04 |
| S6 | 3.0681E−04 | −2.9679E−04 | −9.5852E−05 | 3.1685E−04 | −1.0263E−04 | −2.2506E−04 | 1.6099E−04 |
| S7 | 1.0567E−04 | 7.1801E−05 | −5.4797E−05 | 9.8827E−05 | −7.1999E−05 | 2.2140E−05 | 8.2962E−05 |
| S8 | −8.8340E−04 | −3.0262E−04 | −6.0466E−04 | −2.5336E−04 | −7.2016E−04 | −6.2890E−04 | −5.5929E−04 |

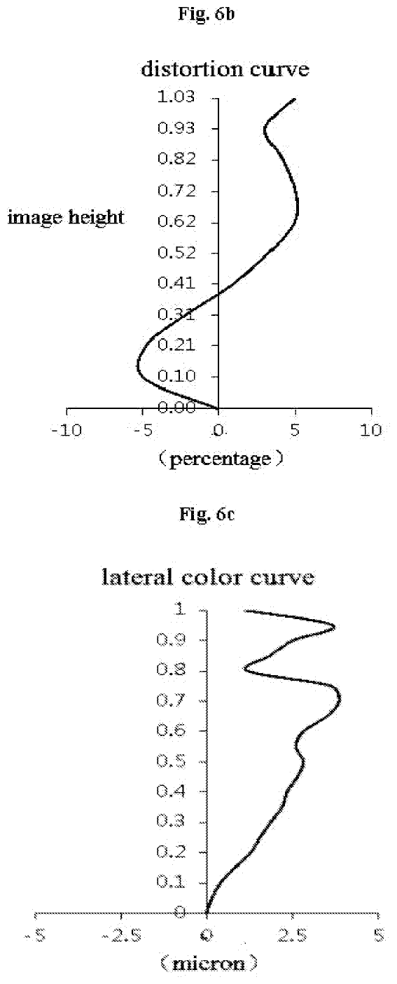

FIG. 6a shows a longitudinal aberration curve of the optical imaging system according to Embodiment 3 to represent deviations of a convergence focal point after light with different wavelengths passes through the lens. FIG. 6b shows a distortion curve of the optical imaging system according to Embodiment 3 to represent distortion values corresponding to different image heights. FIG. 6c shows a lateral color curve of the optical imaging system according to Embodiment 3 to represent deviations of different image heights on the imaging surface after the light passes through the lens. According to FIGS. 6a-6c, it may be seen that the optical imaging system provided in Embodiment 3 is capable of achieving good imaging quality.

### Embodiment 4

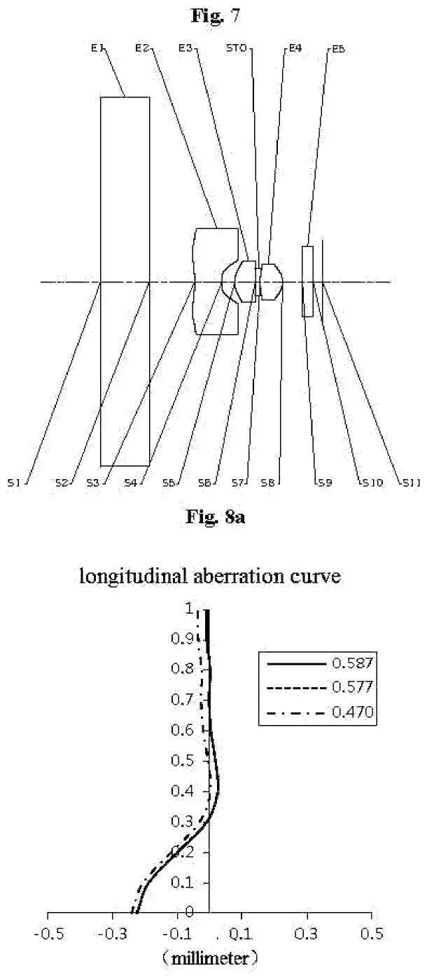

FIG. 7 shows a structural schematic diagram of a lens group of an optical imaging system according to Embodiment 4 of the disclosure. The optical imaging system sequentially includes from an object side to an image side along an optical axis: a glass screen E1, a first lens E2, a second lens E3, a diaphragm STO, a third lens E4, an optical filter E5 and an imaging surface S11.

The glass screen E1 has an object-side surface S1 and an image-side surface S2. The first lens E2 has a negative refractive power, an object-side surface S3 thereof is a concave surface, and an image-side surface S4 thereof is a concave surface. The second lens E3 has a positive refractive power, an object-side surface S5 thereof is a convex surface, and an image-side surface S6 thereof is a concave surface. The third lens E4 has a positive refractive power, an object-side surface S7 thereof is a convex surface, and an image-side surface S8 thereof is a convex surface. The optical filter E5 has an object-side surface S9 and an image-side surface S10. Light from an object sequentially passes through each of the surfaces from S1 to S10 and is finally imaged on the imaging surface S11.

Table 10 shows a table of basic parameters for the optical imaging system of Embodiment 4, wherein the units of the curvature radius, thickness and focal length are all millimeters (mm).

TABLE 10

| Surface | Surface | Curvature | Thickness/ | Focal | Refractive | Abbe | Cone |
|---|---|---|---|---|---|---|---|
| number | type | radius | distance | length | index | number | coefficient |
| OBJ | Spherical | Infinity | 0.0000 | | | | |
| S1 | Spherical | Infinity | 1.0000 | | 1.52 | 64.2 | 0.0000 |
| S2 | Spherical | Infinity | 0.9562 | | | | 0.0000 |
| S3 | Aspheric | −33.4390 | 0.5000 | −0.66 | 1.54 | 56.1 | −1.0000 |
| S4 | Aspheric | 1.6777 | 0.2752 | | | | 0.0000 |
| S5 | Aspheric | 0.5592 | 0.4165 | 0.89 | 1.62 | 25.9 | 0.0000 |
| S6 | Aspheric | 28.6065 | 0.0550 | | | | 0.0000 |
| STO | Spherical | Infinity | 0.0539 | | | | 0.0000 |
| S7 | Aspheric | 1.5265 | 0.4501 | 0.62 | 1.54 | 56.1 | 0.0000 |
| S8 | Aspheric | −0.3921 | 0.4055 | | | | −1.0000 |
| S9 | Spherical | Infinity | 0.2100 | | 1.52 | 64.2 | 0.0000 |
| S10 | Spherical | Infinity | 0.1962 | | | | 0.0000 |
| S11 | Spherical | Infinity | | | | | |

As shown in Table 11, in Embodiment 4, f is a total effective focal length of the optical imaging system, and f=0.35 mm, TTL is a distance from the object-side surface S3 of the first lens E2 to the imaging surface S11 on the optical axis, and TTL=2.56 mm, lmgH is a half of a diagonal length of an effective pixel region on the imaging surface S11, and lmgH=1.02 mm, and Semi-FOV is a half of a maximum field of view of the optical imaging system Semi-FOV=78.36°. The parameters of the relational expressions are as explained in Embodiment 1, and numerical values of the relational expressions are listed in the following table.

TABLE 11
Embodiment 4

| | | | |
|---|---|---|---|
| f(mm) | 0.35 | f1(mm) | −0.66 |
| TTL(mm) | 2.56 | ImgH(rnm) | 1.02 |
| Semi-FOV(°) | 78.36 | Fno | 1.51 |
| f/EPD | 1.51 | f2/f3 | 1.44 |
| \|(f2 + f3)/f1\| | 2.29 | f3/R5 + f3/R6 | −1.17 |
| f * tan(Semi-FOV)/R3 | 3.04 | CT3/ET3 | 1.88 |
| YO/ImgH | 4.45 | TD/TO | 0.89 |
| SL(mm) | 1.32 | SAG12/T12 | 1.22 |

In Embodiment 4, both of the object-side surface and the image-side surface of any one of the first lens E2 to the third lens E4 are aspheric surfaces, and Table 12 shows high order term coefficients A4, A6, A8, Al 0, Al2, A14, A16, A18, A20, A22, A24, A26, A28 and A30 that may be used for each of the aspheric mirror surfaces S3-S8 in Embodiment 4.

TABLE 12

| Surface number | A4 | A6 | A8 | A10 | A12 | A14 | A16 |
|---|---|---|---|---|---|---|---|
| S3 | −2.1114E−01 | −1.0015E−01 | −6.5041E−02 | −3.5400E−02 | −2.1768E−02 | −1.3988E−02 | −9.1021E−03 |
| S4 | 3.9537E−01 | −1.1045E−01 | 2.7888E−02 | 1.8296E−03 | 1.5072E−03 | −2.9622E−03 | 5.3496E−04 |
| S5 | −1.2584E−01 | 5.6268E−03 | −3.9671E−03 | 4.8832E−03 | −1.2687E−03 | 1.5139E−03 | −8.5685E−04 |
| S6 | 5.9641E−02 | −4.1349E−02 | 2.4665E−02 | −1.2456E−02 | 7.1332E−03 | −3.7436E−03 | 9.2115E−04 |
| S7 | −1.2713E−02 | 6.0588E−03 | −1.7713E−03 | 7.5702E−04 | −3.1996E−04 | 4.3473E−04 | −1.1273E−04 |
| S8 | 1.9982E−01 | 2.1425E−02 | 6.9982E−03 | −5.6672E−03 | 7.6120E−04 | 1.3166E−05 | 1.3751E−03 |
| Surface number | A18 | A20 | A22 | A24 | A26 | A28 | A30 |
| S3 | −5.8536E−03 | −3.8561E−03 | −2.5175E−03 | −1.6696E−03 | −1.2721E−03 | −6.9008E−04 | −1.5244E−04 |
| S4 | 4.9346E−04 | 1.4666E−03 | −1.8335E−04 | −1.2000E−03 | −2.0379E−03 | −1.2991E−03 | −6.8762E−04 |
| S5 | 4.6617E−04 | −2.9030E−04 | 5.5657E−04 | 1.7961E−04 | 5.0428E−04 | 1.5837E−04 | 2.2395E−04 |
| S6 | 3.6256E−04 | −2.5493E−04 | −4.1251E−05 | −1.0502E−04 | 2.0125E−05 | 1.6626E−04 | −2.1782E−04 |
| S7 | 4.2842E−05 | −2.1687E−04 | −9.7667E−05 | −1.2106E−04 | −9.1585E−07 | −1.1912E−05 | 3.6993E−05 |
| S8 | −8.6822E−04 | −5.3443E−04 | −7.3186E−04 | −6.1421E−05 | −3.3958E−04 | −1.4395E−04 | −2.2228E−04 |

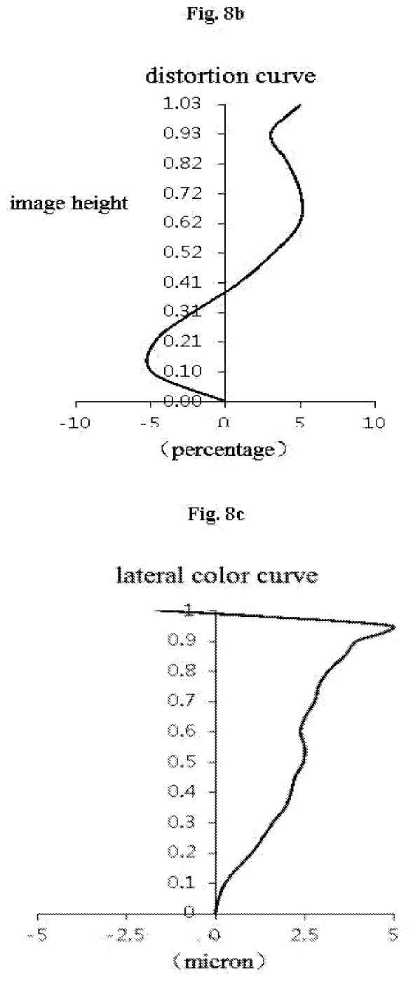

FIG. 8a shows a longitudinal aberration curve of the optical imaging system according to Embodiment 4 to represent deviations of a convergence focal point after light with different wavelengths passes through the lens. FIG. 8b shows a distortion curve of the optical imaging system according to Embodiment 4 to represent distortion values corresponding to different image heights. FIG. 8c shows a lateral color curve of the optical imaging system according to Embodiment 4 to represent deviations of different image heights on the imaging surface after the light passes through the lens. According to FIGS. 8a-8c, it may be seen that the optical imaging system provided in Embodiment 4 is capable of achieving good imaging quality.

### Embodiment 5

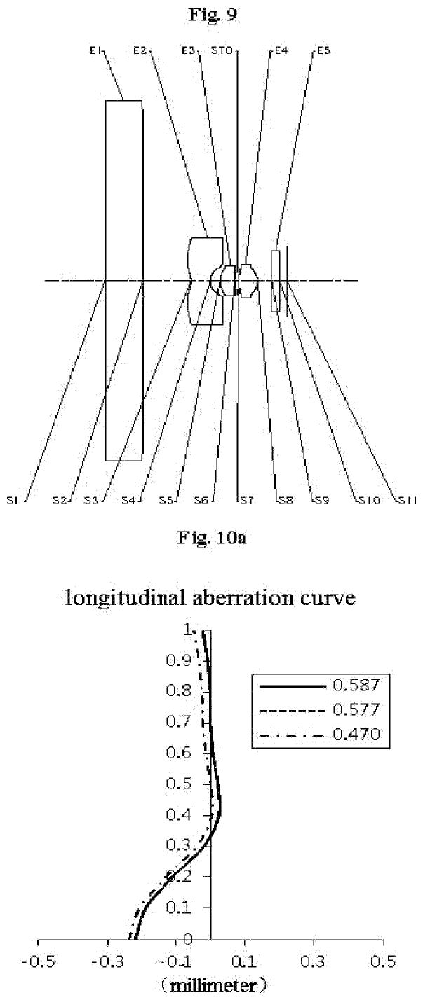

FIG. 9 shows a structural schematic diagram of a lens group of an optical imaging system according to Embodiment 5 of the disclosure. The optical imaging system sequentially includes from an object side to an image side along an optical axis: a glass screen E1, a first lens E2, a second lens E3, a diaphragm STO, a third lens E4, an optical filter E5 and an imaging surface S11.

The glass screen E1 has an object-side surface S1 and an image-side surface S2. The first lens E2 has a negative refractive power, an object-side surface S3 thereof is a concave surface, and an image-side surface S4 thereof is a concave surface. The second lens E3 has a positive refractive power, an object-side surface SS thereof is a convex surface, and an image-side surface S6 thereof is a concave surface. The third lens E4 has a positive refractive power, an object-side surface S7 thereof is a convex surface, and an image-side surface S8 thereof is a convex surface. The optical filter ES has an object-side surface S9 and an image-side surface S10. Light from an object sequentially passes through each of the surfaces from S1 to S10 and is finally imaged on the imaging surface S11.

Table 13 shows a table of basic parameters for the optical imaging system of Embodiment 5, wherein the units of the curvature radius, thickness and focal length are all millimeters (mm).

TABLE 13

| Surface | Surface | Curvature | Thickness/ | Focal | Refractive | Abbe | Cone |
|---|---|---|---|---|---|---|---|
| number | type | radius | distance | length | index | number | coefficient |
| OBJ | Spherical | Infinity | 0.0000 | | | | |
| S1 | Spherical | Infinity | 1.0000 | | 1.52 | 64.2 | 0.0000 |
| S2 | Spherical | Infinity | 1.2693 | | | | 0.0000 |
| S3 | Aspheric | −0.5465 | 0.5129 | −0.66 | 1.54 | 56.1 | −1.0000 |
| S4 | Aspheric | 1.4159 | 0.2529 | | | | 0.0000 |
| S5 | Aspheric | 0.5305 | 0.3868 | 0.87 | 1.62 | 25.9 | 0.0000 |
| S6 | Aspheric | 46.4848 | 0.0592 | | | | −99.0000 |
| STO | Spherical | Infinity | 0.0452 | | | | 0.0000 |
| S7 | Aspheric | 1.4088 | 0.5000 | 0.60 | 1.54 | 56.1 | 0.0000 |
| S8 | Aspheric | −0.3703 | 0.3675 | | | | −1.0000 |
| S9 | Spherical | Infinity | 0.2100 | | 1.52 | 64.2 | 0.0000 |
| S10 | Spherical | Infinity | 0.1962 | | | | 0.0000 |
| S11 | Spherical | Infinity | | | | | |

As shown in Table 14, in Embodiment 5, f is a total effective focal length of the optical imaging system, and f=0.35 mm, TTL is a distance from the object-side surface S3 of the first lens E2 to the imaging surface S11 on the optical axis, and TTL=2.53 mm, lmgH is a half of a diagonal length of an effective pixel region on the imaging surface S11, and lmgH=1.02 mm, and Semi-FOV is a half of a maximum field of view of the optical imaging system Semi-FOV=80.25°. The parameters of the relational expressions are as explained in Embodiment 1, and numerical values of the relational expressions are listed in the following table.

TABLE 14
Embodiment 5

| | | | |
|---|---|---|---|
| f(mm) | 0.35 | f1(mm) | −0.66 |
| TTL(mm) | 2.53 | ImgH(rnm) | 1.02 |
| Semi-FOV(°) | 80.25 | Fno | 1.51 |
| f/EPD | 1.51 | f2/f3 | 1.45 |
| \|(f2 + f3)/f1\| | 2.23 | f3/R5 + f3/R6 | −1.19 |
| f * tan(Semi-FOV)/R3 | 3.84 | CT3/ET3 | 1.89 |
| YO/ImgH | 5.38 | TD/TO | 0.77 |
| SL(mm) | 1.32 | SAG12/T12 | 1.20 |

In Embodiment 5, both of the object-side surface and the image-side surface of any one of the first lens E2 to the third lens E4 are aspheric surfaces, and Table 15 shows high order term coefficients A4, A6, A8, A10, A12, A14, A16, A18, A20, A22, A24, A26, A28 and A30 that may be used for each of the aspheric mirror surfaces S3-S8 in Embodiment 5.

TABLE 15

| Surface number | A4 | A6 | A8 | A10 | A12 | A14 | A16 |
|---|---|---|---|---|---|---|---|
| S3 | 1.8303E+00 | −4.1604E−01 | 1.3607E−01 | −5.3727E−02 | 2.4047E−02 | −1.1454E−02 | 5.7189E−03 |
| S4 | 3.9393E−01 | −1.1316E−01 | 3.2259E−02 | 5.4796E−03 | 1.1993E−03 | −4.8101E−03 | 1.0536E−03 |
| S5 | −1.2773E−01 | 3.0533E−03 | −5.7027E−03 | 5.5631E−03 | −9.7191E−04 | 1.4986E−03 | −1.0608E−03 |
| S6 | 1.8509E−02 | −4.6995E−03 | −2.1080E−03 | −1.2899E−03 | −4.1717E−04 | −4.7949E−04 | −1.6843E−04 |
| S7 | −1.2977E−02 | 5.6157E−03 | −1.6427E−03 | 8.3443E−04 | −4.5715E−04 | 2.8962E−04 | −1.7264E−04 |
| S8 | 1.9671E−01 | 1.0922E−02 | 8.2152E−03 | −3.7530E−03 | 8.7238E−04 | −1.3828E−03 | 1.1247E−03 |
| Surface number | A18 | A20 | A22 | A24 | A26 | A28 | A30 |
| S3 | −2.9358E−03 | 1.5622E−03 | −8.5234E−04 | 4.3551E−04 | −2.4457E−04 | 1.1542E−04 | −2.3037E−05 |
| S4 | 1.5807E−03 | 1.6520E−03 | −7.2067E−04 | −1.4407E−03 | −1.9244E−03 | −9.8555E−04 | −5.7069E−04 |
| S5 | 3.6256E−04 | −3.9603E−04 | 5.5542E−04 | 2.2003E−04 | 6.1944E−04 | 2.2726E−04 | 2.5898E−04 |
| S6 | −6.9290E−05 | 4.7026E−05 | −1.9976E−05 | 4.6424E−06 | 6.5520E−06 | 3.5913E−05 | 2.3311E−06 |
| S7 | 1.2924E−04 | −7.9727E−05 | 4.2057E−05 | −3.6317E−05 | 2.2073E−05 | −2.7392E−05 | 1.4175E−05 |
| S8 | −1.4661E−04 | 1.2445E−04 | −8.8663E−04 | −6.5803E−04 | −9.1727E−04 | −4.4007E−04 | −2.6684E−04 |

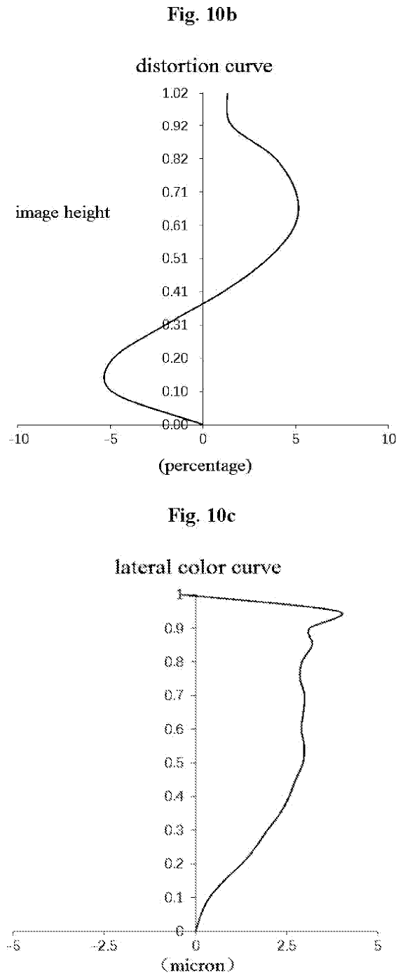

FIG. 10a shows a longitudinal aberration curve of the optical imaging system according to Embodiment 5 to represent deviations of a convergence focal point after light with different wavelengths passes through the lens. FIG. 10b shows a distortion curve of the optical imaging system according to Embodiment 5 to represent distortion values corresponding to different image heights. FIG. 10c shows a lateral color curve of the optical imaging system according to Embodiment 5 to represent deviations of different image heights on the imaging surface after the light passes through the lens. According to FIGS. 10a-10c, it may be seen that the optical imaging system provided in Embodiment 5 is capable of achieving good imaging quality.

What is described above are merely preferred embodiments of the disclosure, and are not intended to limit the disclosure. Any modifications, improvements and equivalent replacements made within the spirit and principle of the disclosure should fall within the protection scope of the disclosure.

What is claimed is:

1. An optical imaging system, sequentially comprising from an object side to an image side along an optical axis:
a first lens with a negative refractive power, an object-side surface thereof is a concave surface;
a second lens with a positive refractive power; and
a third lens with a positive refractive power;
wherein an effective focal length f of the optical imaging system and, an Entrance Pupil Diameter (EPD) of the optical imaging system satisfy: f/EPD<1.6; and Semi-FOV is a half of a maximum field of view of the optical imaging system, and Semi-FOV satisfies: Semi-FOV>70°.

2. The optical imaging system according to claim 1, wherein an effective focal length f2 of the second lens, an effective focal length f3 of the third lens and an effective focal length f1 of the first lens satisfy: 2.0<|(f2+f3)/f1|<2.5.

3. The optical imaging system according to claim 1, wherein an effective focal length f3 of the third lens, a curvature radius R5 of an object-side surface of the third lens and a curvature radius R6 of an image-side surface of the third lens satisfy: −1.6<f3/R5+f3/R6<−0.9.

4. The optical imaging system according to claim 1, wherein the effective focal length f of the optical imaging system, Semi-FOV and a curvature radius R3 of an object-side surface of the second lens satisfy: 1.5<f*tan(Semi-FOV)/R3<4.0.

5. The optical imaging system according to claim 1, wherein a center thickness CT3 of the third lens on the optical axis and an edge thickness ET3 of the third lens satisfy: 1.5<CT3/ET3<2.1.

6. The optical imaging system according to claim 1, wherein YO is an object height of a maximum imaging height of the optical imaging system, lmgH is a half of a diagonal length of an effective pixel region on an imaging surface, YO and lmgH satisfy: 4.0<YO/lmgH<5.5.

7. The optical imaging system according to claim 1, wherein TD is an on-axis distance from the object-side surface of the first lens to an image-side surface of the last lens, TO is a distance from a photographed object to the object-side surface of the first lens on the optical axis, TD and TO satisfy: 0.5<TD/TO<1.0.

8. The optical imaging system according to claim 1, wherein an on-axis distance SL from an aperture to the imaging surface satisfies: 1.0 mm<SL<1.5 mm.

9. The optical imaging system according to claim 1, wherein SAG12 is an on-axis distance from an intersection point of an image-side surface of the first lens and the optical axis to an effective radius vertex of the image-side surface of the first lens, and SAG12 and an air space T12 between the first lens and the second lens on the optical axis satisfy: 1.0<SAG12/T12<1.5.

10. An optical imaging system, sequentially comprising from an object side to an image side along an optical axis:
a first lens with a negative refractive power, an object-side surface thereof is a concave surface;
a second lens with a refractive power; and
a third lens with a refractive power;
wherein an effective focal length f2 of the second lens and an effective focal length f3 of the third lens satisfy a conditional expression: 0.5<f2/f3<1.7; and Semi-FOV is a half of a maximum field of view of the optical imaging system, and Semi-FOV satisfies: Semi-FOV>70°.

11. The optical imaging system according to claim 10, wherein an effective focal length f2 of the second lens, an effective focal length f3 of the third lens and an effective focal length f1 of the first lens satisfy: 2.0<|(f2+f3)/f1|<2.5.

12. The optical imaging system according to claim 10, wherein an effective focal length f3 of the third lens, a curvature radius R5 of an object-side surface of the third lens and a curvature radius R6 of an image-side surface of the third lens satisfy: −1.6<f3/R5+f3/R6<−0.9.

13. The optical imaging system according to claim 10, wherein the effective focal length f of the optical imaging system, Semi-FOV and a curvature radius R3 of an object-side surface of the second lens satisfy: 1.5<f*tan(Semi-FOV)/R3<4.0.

14. The optical imaging system according to claim 10, wherein a center thickness CT3 of the third lens on the optical axis and an edge thickness ET3 of the third lens satisfy: 1.5<CT3/ET3<2.1.

15. The optical imaging system according to claim 10, wherein YO is an object height of a maximum imaging height of the optical imaging system, lmgH is a half of a diagonal length of an effective pixel region on an imaging surface, YO and lmgH satisfy: 4.0<YO/lmgH<5.5.

16. The optical imaging system according to claim 10, wherein TD is an on-axis distance from the object-side surface of the first lens to an image-side surface of the last lens, TO is a distance from a photographed object to the object-side surface of the first lens on the optical axis, TD and TO satisfy: 0.5<TD/TO<1.0.

17. The optical imaging system according to claim 10, wherein an on-axis distance SL from an aperture to the imaging surface satisfies: 1.0 mm<SL<1.5 mm.

18. The optical imaging system according to claim 10, wherein SAG12 is an on-axis distance from an intersection point of an image-side surface of the first lens and the optical axis to an effective radius vertex of the image-side surface of the first lens, and SAG12 and an air space T12 between the first lens and the second lens on the optical axis satisfy: 1.0<SAG12/T12<1.5.

19. A recognition module, comprising the optical imaging system according to claim 1 and an electronic photosensitive element, wherein the electronic photosensitive element is arranged on an imaging surface of the optical imaging system.

20. An electronic device, comprising the recognition module according to claim 19.
